(19) United States
(12) Patent Application Publication
(10) Pub. No.: US 2008/0282852 A1
(43) Pub. Date: Nov. 20, 2008

(54) SCREW DRIVER GUN

(76) Inventors: KUO-CHOU WANG, KAOHSIUNG COUNTY (TW); KUAN-HSIANG WANG, KAOHSIUNG COUNTY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/756,813

(22) Filed: Jun. 1, 2007

(30) Foreign Application Priority Data
May 15, 2007 (TW) 09627839

(51) Int. Cl. B25B 23/06

(52) U.S. Cl. 81/434

(57) ABSTRACT

The present invention relates to a screw driver gun, in particular a driver bit sleeve of the screw driver gun includes an adjoining hole connecting to a polygonal concavity, which is formed on the free end of the driver bit sleeve; a driver device is disposed in the sleeve and comprises a driver bit penetrating through the hole and a spring on the back thereof; the driver bit can rotate with the driver bit sleeve at the same time. While in use, the polygonal concavity can exactly fit with the polygonal screw head by the driver tip of the driver bit driving into the screw recess to synchronize the screw rotating with the driver bit sleeve, thereby reducing the problem of inaccurate driving, transmitting a force equally toward the screw head, and increasing the screwing efficiency.

### BACKGROUND OF THE INVENTION

1. Field of the Invention

The present invention relates to a screw driver gun, in particular a screw driver gun that can exactly transmit a force to the screw head and increase the screwing accuracy and efficiency.

2. Description of the Related Art

Referring to FIG. 1, while in use, a conventional hex head screw 1 usually cooperates with an actuating tool 2 and a hex driver sleeve 21 disposed therein. Users need to manually insert the hex head screw 1 into the driver sleeve 21 of the tool 2 while screwing; however, the hand operating increases the screwing time. Consequently, users change to exert a screw driver gun 4 to screw the hex head screws 1 of a screw strip 3 into the object.

Referring to FIG. 2, the screw driver gun 4 includes a body 41, a fixing section 42 extending outwardly from the body 41, a driver sleeve 44 disposed within the fixing section 42, and a movable section 45 disposed on a side of the fixing section 42; wherein, the body 41 has a power apparatus 46 to rotate the driver sleeve 44; furthermore, a free end 441 is formed on the front end of the driver sleeve 44, and a hexagonal concavity 442 is disposed thereon. A passage 451 is disposed along the end of the movable section 45 for the movement of the screw strip 3. In use, the screw strip 3 is initially moved along the passage 451 to the movable section 45; further, while pointing the screw driver gun 4 to the object 5, the driver sleeve 44 is rotated by the power apparatus 46 and the movable section 45 begins to move on the fixing section 42. Thus, the screw head 11 of the screw 1 gradually inserts into the hexagonal concavity 442, and the driver sleeve 44 drives the screw 1 to be screwed into the object 5.

However, the conventional screw driver gun 4 still has some disadvantages:

### 1. Decreasing the Efficiency of Screwing

Due to the high speed driving by the power apparatus 46, the driver sleeve 44 easily rotates idly while operating, and that would cause the hexagonal concavity 442 to incompletely fit with the screw head 11. Thus, the hex head screw 1 can not be screwed into the objects and affect the screwing efficiency.

2. Reducing the Advancing Force Toward the Screw

According to the above description, the hexagonal concavity 442 can not fully accommodate the screw head 11, so the power apparatus 46 can also not exactly transmit a force to the screw head 11 to drive the hex head screw 1 into the object 5. However, the hex head screw 1 would also easily become slanted after screwing by the unequal contact of the concavity 442 and the screw 1.

### SUMMARY OF THE INVENTION

The objects of the present invention are to provide a screw driver gun which can increase the accuracy of the polygonal concavity fitting with the polygonal screw head and transmit a force equally to the screw.

The screw driver gun in accordance with the present invention comprises a body, a fixing section extending outwardly from the body, a driver bit sleeve disposed within the fixing section, and a movable section disposed on a side of the fixing section; particularly, an adjoining hole is formed in the driver bit sleeve and connects to the polygonal concavity of the sleeve; furthermore, the driver bit sleeve has a driver device, which includes a driver bit and a spring disposed on the back thereof. The driver bit projects into the adjoining hole and rotates with the driver bit sleeve at the same time.

By means of the above elements, the driver bit initially drives into the recess of the screw head to rotate the polygonal screw, thus, the polygonal concavity can accurately fit with the screw head and help the screw be screwed into the objects.

### BRIEF DESCRIPTION OF THE DRAWINGS

The advantages of the present invention over the known prior art will become more apparent to those of ordinary skilled in the art upon reading the following descriptions in conjunction with the accompanying drawings.

FIG. 1 is a schematic view showing a conventional screw driver sleeve cooperating with a hex head screw;

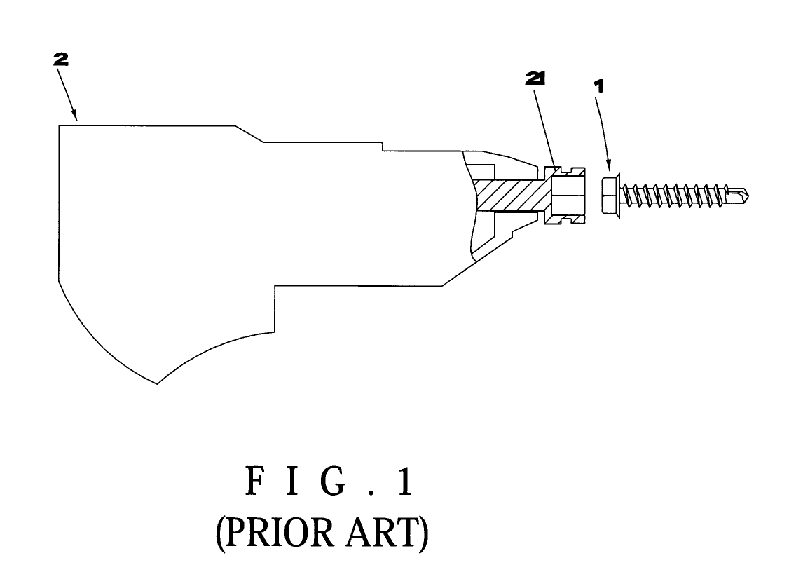

FIG. 2 is a schematic view showing a conventional screw driver gun;

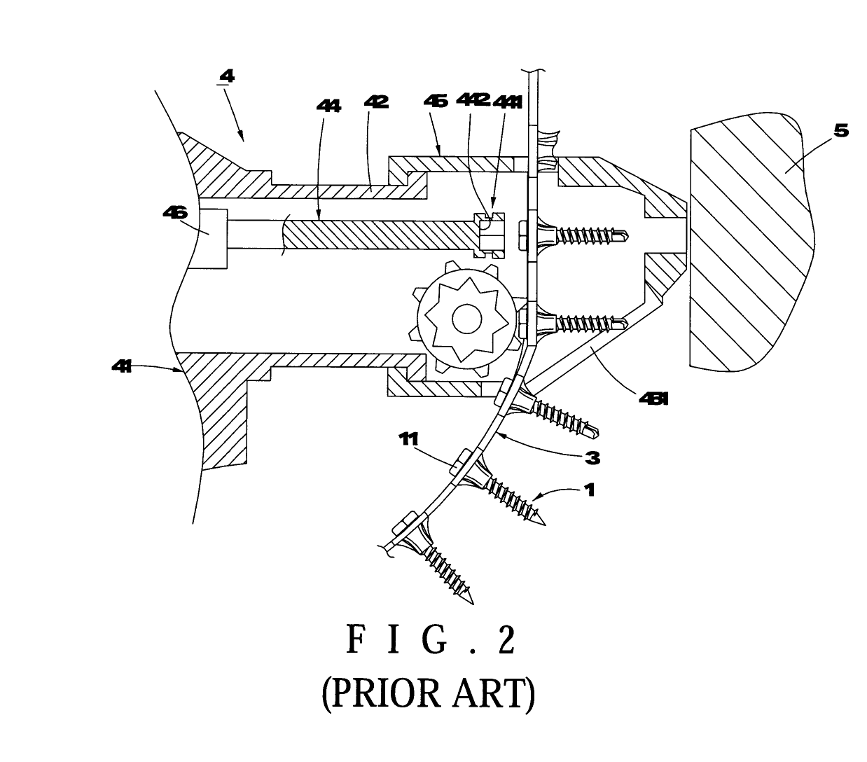

FIG. 3 is a schematic view showing the first preferred embodiment of the present invention;

FIG. 4 is a partly sectional schematic view showing the driver bit sleeve of the first preferred embodiment;

FIG. 5 is a perspective view showing the hex head screws of a screw strip used in the first preferred embodiment; and

FIG. 6 is a schematic view showing the state of driver bit sleeve fitting with the screw of the first preferred embodiment.

### DETAILED DESCRIPTION OF THE PREFERRED EMBODIMENTS

Before the present invention is described in greater detail, it should be noted that the like elements are denoted by the same reference numerals throughout the disclosure.

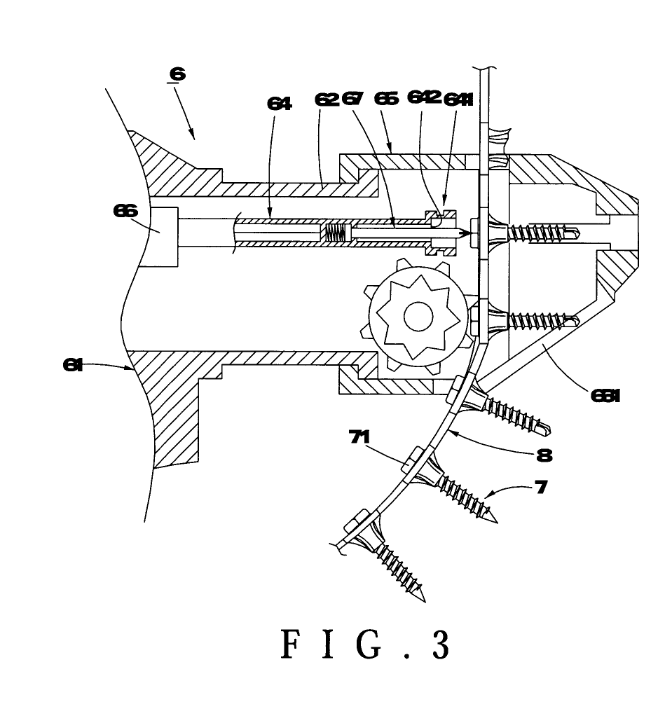

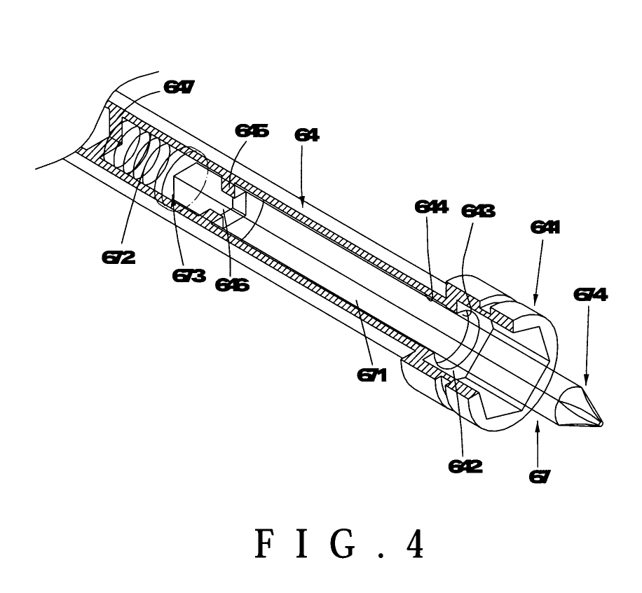

Referring to FIG. 3, the screw driver gun 6 of the first preferred embodiment comprises a body 61, a fixing section 62 extending outwardly from the body 61, a driver bit sleeve 64 disposed within the fixing section 62, and a movable section 65 disposed on a side of the fixing section 62, which is opposite to the body 61; wherein, the above elements are the same as the conventional screw driver gun 4. To be more specific, as referring to FIG. 4, a polygonal concavity 642 is formed on the free end 641 of the driver bit sleeve 64, and can be a quadrangular or hexagonal shape; the hexagonal shape is adopted in the embodiment. Particularly, the driver bit sleeve 64 has a surrounding wall 644 therein; an adjoining hole 643 formed by the encirclement of the surrounding wall 644 joins to the hexagonal concavity 642 of the sleeve 64; an inner protrusion 645 and a side wall 647 protrude inwardly from the surrounding wall 644; an opening 646, which is formed a quadrangular shape, is defined by the surrounding of the inner protrusion 645.

Continuing with the above, the driver bit sleeve 64 has a driver device 67, which includes a driver bit 671 and a spring 672 disposed behind the driver bit 671; wherein, the driver bit 671 projects into the adjoining hole 643 and penetrates through the opening 646; the driver bit 671 has the same shape as the opening 646 and synchronously rotates with the driver bit sleeve 64; a shield portion 673 is formed on the backward end of the driver bit 671, which is located between the inner protrusion 645 and the spring 672; a driver tip 674 is defined at the front end thereof and projects out of the hexagonal concavity 642; furthermore, the spring 672 is located between the shield portion 673 and the side wall 647.

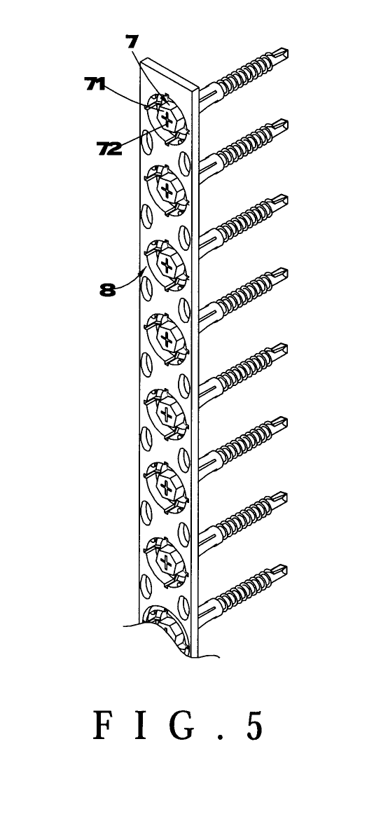

Referring to FIG. 5, before operating, the hex head screw 7 should be designed to have a screw recess 72 disposed on the screw head 71, and a plurality of screws 7 penetrate into a screw strip 8.

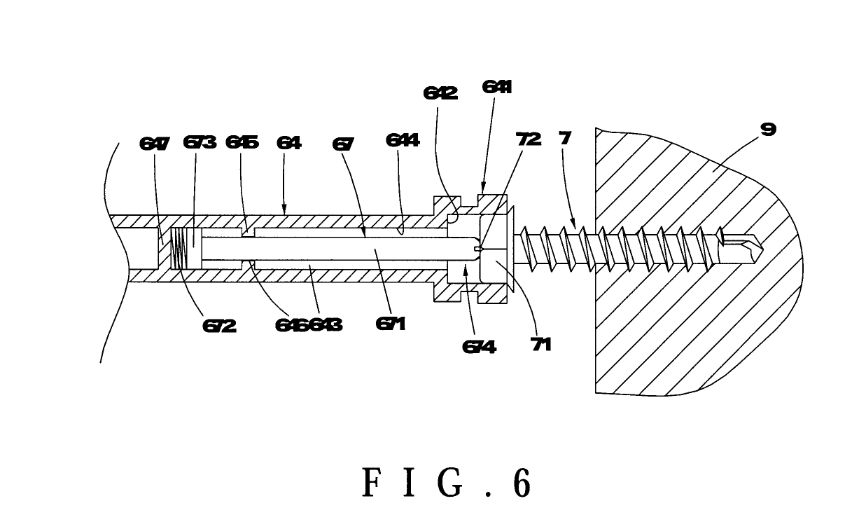

Referring to FIG. 3 and FIG. 6, while in operating, the screw strip 8 is moved along the passage 651 to the movable section 65; further, when the screw driver gun 6 directs toward the object 9, and simultaneously the power apparatus 66 rotate the driver bit sleeve 64, the movable section 65 begins to move on the fixing section 62. Thus, the movement of the movable section 65 renders the driver tip 674 driving into the screw recess 72, and the hex head screw 7 is also rotated by the rotation of the driver bit 671 and the driver bit sleeve 64, so that the hexagonal concavity 642 can gradually and fully fit with the screw head 71. The driver bit sleeve 64 hence can also transmit a force equally to the screw head 71 and accurately screw the hex head screw 7 into the object 9, so as to eliminate the problems of inclining or slipping while screwing. After screwing, the spring 672 pushes the driver bit 671 to project out of the driver bit sleeve 64 for the next screwing procedure.

According to above description, the present invention has following advantages and functions:

1. Accurately and Completely Fit with the Screw Head Due to the driver tip of the driver bit initially driving into the screw recess, the hex head screw can rotate with the driver bit and the driver bit sleeve simultaneously, so that the hexagonal concavity can fully and exactly fit with the screw head. Consequently, the driver bit sleeve would not rotate idly and would efficiently drive the screw into the object.

2. Equally Transmitting a Force to the Screw

According to the aforementioned, the hexagonal concavity can accurately fit with the screw head, and the driver bit sleeve thus can exactly transmit a force to the screw head and aid in screwing the screw firmly into the object. Moreover, the situation of the inclining or slipping would also be reduced.

To sum up, the present invention takes advantage of the hex head screw and the driver bit sleeve rotating simultaneously by the driver tip of driver bit initially driving into the screw recess, the hexagonal concavity thus can achieve the object of fully and accurately fitting with the screw head. Furthermore, the present invention prevents the driver bit sleeve from being worn or inclined while using and increases the screwing efficiency.

While we have shown and described the embodiment in accordance with the present invention, it should be clear to those skilled in the art that further embodiments may be made without departing from the scope of the present invention.

I claim:

1. A screw driver gun comprising:
a body;
a fixing section extending outwardly from said body;
a driver bit sleeve disposed within said fixing section; and
a movable section disposed on a side of said fixing section, which is opposite to said body; wherein, said body has a power apparatus to rotate said driver bit sleeve; a free end, which is opposite to said power apparatus, is formed at the front end of said driver bit sleeve, and a polygonal concavity is disposed on said free end; a passage is arranged along with the forward end of said movable section for the movement of a screw strip;
wherein said driver bit sleeve has a surrounding wall therein; an adjoining hole is formed by the encirclement of said surrounding wall, and said adjoining hole connects to said polygonal concavity; an inner protrusion and a side wall protrudes inwardly from said surrounding wall, and an opening is defined by the surrounding of said inner protrusion; said driver bit sleeve includes a driver device, which includes a driver bit projecting into said adjoining hole and penetrating through said opening, and a spring disposed on the back of said driving bit; wherein, said driver bit and said driver bit sleeve rotate simultaneously; a shield portion is formed on the backward end of said driver bit, which is located between said inner protrusion and said spring; a driver tip is defined at the front end of said driver bit and projects out of said polygonal concavity.

2. The screw driver gun as claimed in claim 1, wherein said driver bit forms a polygonal shape and corresponds with the shape of said opening.
